(19) United States
(12) Patent Application Publication
(10) Pub. No.: US 2019/0330018 A1
(43) Pub. Date: Oct. 31, 2019

(54) LIFT RUNNING SPEED MEASUREMENT METHOD AND SYSTEM

(71) Applicant: Shenzhen Technology University, Shenzhen (CN)

(72) Inventors: Jianmin Cao, Shenzhen (CN); Ruize Sun, Shenzhen (CN)

(21) Appl. No.: 16/412,410

(22) Filed: May 14, 2019

Related U.S. Application Data
(63) Continuation of application No. PCT/CN2018/084887, filed on Apr. 27, 2018.

(51) Int. Cl. B66B 5/04; B66B 3/00; G01P 3/66; G01P 11/00

(52) U.S. Cl. CPC B66B 5/04; G01P 11/00; G01P 3/66; B66B 3/00

(57) ABSTRACT

The present disclosure provides a lift running speed measurement method and system. Record a q^{th} start time of a lift when the lift starts on a start floor, and record a q^{th} stop time and a q^{th} floor number when the lift stops running on a q^{th} destination floor. Compute a q^{th} time difference between the q^{th} stop time and the q^{th} start time. If the q is less than the statistic times Q, record q=q+1 and return to carry out the step of starting the lift on the start floor; if the q is greater than or equal to the statistic times Q, respectively compute a difference between a time difference of each value from 2^{nd} to Q^{th} and a 1^{st} time difference, and a difference between a floor number of each value from 2^{nd} to Q^{th} and a 1^{st} floor number.

### CROSS REFERENCE TO RELATED APPLICATIONS

The present application is a Continuation Application of PCT Application No. PCT/CN2018/084887 filed on Apr. 27, 2018, the contents of which are incorporated herein by reference in its entirety.

### TECHNICAL FIELD

The present disclosure relates to the field of lift monitoring, and in particular to a lift running speed measurement method and system.

### BACKGROUND

Running speed of a lift is a basic parameter for designing the lift and also is an important basis for judging whether the lift in use is safe and reliable or not. Currently, the lift industry always utilizes two lift car running speed measurement methods given in GB/T 10059-1997 Lifts-Testing Methods implemented from Oct. 1, 1998. Apparently, it has been infeasible that the running speed of a lift car is indirectly computed by measuring the rotating speed of a traction motor in this gearless traction drive age, but the accuracy of a method for computing the running speed of a lift by measuring the speed of a hoist rope through a speed measurement device is influenced by factors, such as contact reliability, which is influenced by greasy dirt and jitter of the hoist rope, of the hoist rope and a tachometer probe. Furthermore, the running speed of the lift is computed by measuring the start time and the stop time of the lift in certain lift monitoring systems, but a lift running process also comprises starting accelerating and stopping decelerating processes, so the computation complexity of the running speed of the lift is largely improved, and a lot of uncertain factors are also unavoidably generated, thereby causing computation and measurement errors.

### SUMMARY

A main objective of the present disclosure is to provide a lift running speed measurement method and system, which may solve the problems of computation complexity and computation errors of lift running speed measurement.

In order to achieve the above objective, the present disclosure provides a lift running speed measurement method. The method comprises:

step 1, recording a q^{th} start time of a lift when the lift starts on a start floor, and recording a q^{th} stop time and a q^{th} floor number when the lift stops running on a q^{th} destination floor, wherein an initial value of the q is 1, and the q^{th} floor number is not equal to any one value in a range from the 1^{st} floor number to the (q−1)^{th} floor number;

step 2, computing a q^{th} time difference between the q^{th} stop time and the q^{th} start time;

step 3, if the q is less than Q, recording q=q+1 and returning to carry out step 1, wherein the Q represents a preset statistic times, the Q is a positive integer and is greater than or equal to 2 if floor height data can be acquired, and the Q is a positive integer and is greater than or equal to 3 if the floor height data cannot be acquired; and

step 4, if the q is greater than or equal to the Q, respectively computing a difference between a time difference of each value from 2^{nd} to Q^{th} and a 1^{st} time difference, and a difference between a floor number of each value from 2^{nd} to Q^{th} and a 1^{st} floor number, computing to obtain a plurality of lift running speeds, and deriving an average lift running speed.

In order to achieve the above objective, the present disclosure provides a lift running speed measurement system, and the system comprises:

a recording module, used for recording a q^{th} start time of a lift when the lift starts on a start floor, and recording a q^{th} stop time and a q^{th} floor number when the lift stops running on a q^{th} destination floor, wherein an initial value of the q is 1, and the q^{th} floor number is not equal to any one value in a range from the 1^{st} floor number to the (q−1)^{th} floor number;

a first computing module, used for computing a q^{th} time difference between the q^{th} stop time and the q^{th} start time;

a returning module, used for, if the q is less than Q, recording q=q+1 and returning the recording module, wherein the Q represents a preset statistic times, the Q is a positive integer and is greater than or equal to 2 if floor height data can be acquired, and the Q is a positive integer and is greater than or equal to 3 if the floor height data cannot be acquired; and

a second computing module, used for, if the q is greater than or equal to the Q, respectively computing a difference between a time difference of each value from 2^{nd} to Q^{th} and a 1^{st} time difference, and a difference between a floor number of each value from 2^{nd} to Q^{th} and a 1^{st} floor number, computing to obtain a plurality of lift running speeds, and deriving an average lift running speed.

The present disclosure provides a lift running speed measurement method and system. The q^{th} time difference is computed by utilizing the q^{th} stop time and the q^{th} start time; and if the q is greater than the statistic times Q, the difference between the time difference of each value from 2^{nd} to Q^{th} and the 1^{st} time difference, and the difference between the floor number of each value from 2^{nd} to Q^{th} and the 1^{st} floor number are respectively computed, the plurality of the lift running speeds are obtained by computing, and the average lift running speed is acquired; therefore, errors are reduced. Besides, a time difference of each value from 1^{st} to Q^{th} is a once-running total time of the lift, which comprises a starting accelerating time, a braking decelerating time, a creeping time and the like of the lift, and the starting accelerating time, the braking decelerating time, the creeping time and the like of the lift can be eliminated by respectively computing the difference between the time difference of each value from 2^{nd} to Q^{th} and the 1^{st} time difference, so the lift running speeds obtained by computing is not influenced by the starting accelerating time, the braking decelerating time, the creeping time and the like of the lift, and the computing method and the computation amount are largely simplified.

### BRIEF DESCRIPTION OF THE DRAWINGS

To describe the technical schemes in the embodiments of the present disclosure or in the prior art more clearly, the following briefly describes the accompanying drawings required for describing the embodiments or the prior art. Apparently, the accompanying drawings in the following description show some embodiments of the present disclosure, and those skilled in the art may still derive other drawings from these accompanying drawings without creative efforts.

FIG. 1 is a flow schematic diagram of a lift running speed measurement method provided in a first embodiment of the present disclosure.

FIG. 2 is a schematic diagram of a lift running time provided in the first embodiment of the present disclosure.

FIG. 3 is a schematic diagram of a lift running distance provided in the first embodiment of the present disclosure.

FIG. 4 is a structural schematic diagram of a lift running speed measurement system provided in a second embodiment of the present disclosure.

### DESCRIPTION OF THE EMBODIMENTS

To make the objectives, characteristics, and advantages of the present disclosure clearer and more understandable, the following clearly and completely describes the technical schemes in the embodiments of the present disclosure with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

There are technical problems of computation complexity and computation errors of lift running speed measurement in the prior art.

To solve the above-mentioned technical problems, the present disclosure provides a lift running speed measurement method and system. The q^{th} time difference is computed by utilizing the q^{th} stop time and the q^{th} start time; and if the q is greater than the statistic times Q, the difference between the time difference of each value from 2^{nd} to Q^{th} and the 1^{st} time difference, and the difference between the floor number of each value from 2^{nd} to Q^{th} and the 1^{st} floor number are respectively computed, the plurality of the lift running speeds are obtained by computing, and the average lift running speed is acquired; therefore, errors are reduced. Besides, a time difference of each value from 1^{st} to Q^{th} is a once-running total time of the lift, which comprises a starting accelerating time, a braking decelerating time, a creeping time and the like of the lift, and the starting accelerating time, the braking decelerating time, the creeping time and the like of the lift can be eliminated by respectively computing the difference between the time difference of each value from 2^{nd} to Q^{th} and the 1^{st} time difference, so the lift running speeds obtained by computing is not influenced by the starting accelerating time, the braking decelerating time, the creeping time and the like of the lift, and the computing method and the computation amount are largely simplified.

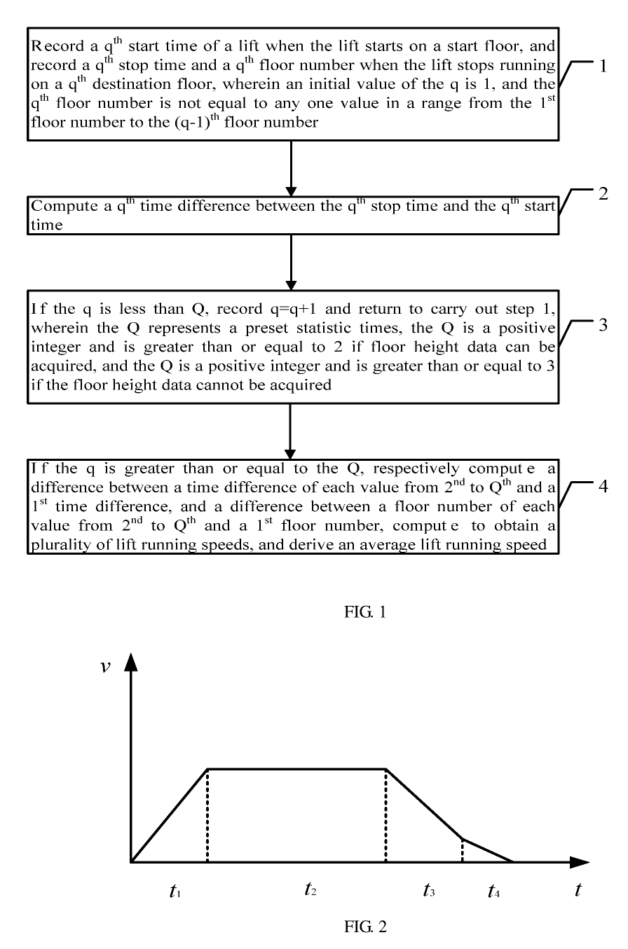

Referring to FIG.1, FIG. 1 is a flow schematic diagram of a lift running speed measurement method provided in a first embodiment of the present disclosure. Specifically, the lift running speed measurement method comprises the following steps:

step 1, recording a q^{th} start time of a lift when the lift starts on a start floor, and recording a q^{th} stop time and a q^{th} floor number when the lift stops running on a q^{th} destination floor, wherein an initial value of the q is 1, and the q^{th} floor number is not equal to any one value in a range from the 1^{st} floor number to the (q−1)^{th} floor number;

step 2, computing a q^{th} time difference between the q^{th} stop time and the q^{th} start time;

step 3, if the q is less than Q, recording q=q+1 and returning to carry out step 1, wherein the Q represents a preset statistic times, the Q is a positive integer and is greater than or equal to 2 if floor height data can be acquired, and the Q is a positive integer and is greater than or equal to 3 if the floor height data cannot be acquired; and

step 4, if the q is greater than or equal to the Q, respectively computing a difference between a time difference of each value from 2^{nd} to Q^{th} and a 1^{st} time difference, and a difference between a floor number of each value from 2^{nd} to Q^{th} and a 1^{st} floor number, computing to obtain a plurality of lift running speeds, and deriving an average lift running speed.

Furthermore, step 4 comprises the following specific step:

according to the following formula, respectively computing a difference between a time difference of each value from 2^{nd} to Q^{th} and a 1^{st} time difference, and a difference between a floor number of each value from 2^{nd} to Q^{th} and a 1^{st} floor number, computing to obtain a plurality of lift running speeds, and deriving an average lift running speed:

(Tₚ-T₁)v=(|Nₚ-N₁|)h

wherein Tₚ represents a p^{th} time difference, T₁ represents a 1^{st} time difference, v represents a lift running speed, Nₚ represents a p^{th} floor number, N₁ represents a 1^{st} floor number, and h represents the floor height data, wherein the value of the p is any one value in a range from 2 to Q.

Furthermore, the start time of each value from 1^{st} to Q^{th} represents an up displayed arrow lighting time of the lift, or a sending time of a lift start signal extracted from a lift communication port.

Furthermore, the stop time of each value from 1^{st} to Q^{th} represents an up displayed arrow extinguishing time of the lift, or a sending time of a lift stop signal extracted from the lift communication port.

Furthermore, a difference between a destination floor number of each value from 2^{nd} to Q^{th} and a 1^{st} destination floor number is greater than one floor number.

It should be noted that, a conventional lift running process comprises four processes, including a starting accelerating process, an average-speed running process, a braking decelerating process and a creeping process, its running time composition is shown in FIG. 2, and FIG. 2 is a schematic diagram of a lift running time provided in the first embodiment of the present disclosure, wherein:

(1) t₁ is the starting accelerating time, and at this time, a traction motor drives a lift car to accelerate at a relatively larger accelerated speed;

(2) t₂ is an average-speed running time, and at this time, the speed is related to a rated rotating speed of the traction motor and is the lift running speed v to be measured in the present disclosure;

(3) t₃ is a braking decelerating time, and at this time, the traction motor brakes to decelerate; and

(4) t₄ is a creeping time, and for ensuring the comfortableness, the lift approaches the destination floor at a creeping speed.

In conclusion, the lift running time T is:

T=t₁+t₂+t₃+t₄ (1)

The corresponding lift running distance is shown in FIG. 3, and FIG. 3 is a schematic diagram of a lift running distance provided in the first embodiment of the present disclosure, wherein:

(1) h₁ is a starting accelerating distance, and generally is less than one floor height;

(2) h₂ is an average-speed running distance, and is a main running distance of the lift;

(3) h₃ is a braking decelerating distance, and generally is less than one floor height; and

(4) h₄ is a creeping distance, and generally is less than 2 m.

In conclusion, the lift running distance H is:

H=h₁+h₂+h₃+h₄ (2)

The lift running floor number variation respectively corresponds to a floor number of the lift from starting to stopping, wherein N represents a start floor number, N₁ represents a destination floor number (which represents a 1^{st} floor number here), and h represents the floor height, so the lift running distance H₁=(|N₁-N|)h, and the corresponding running time is T₁. A formula about lift average-speed running can be computed and obtained by utilizing the formula (1) and the formula (2):

(T₁−t₁−t₃−t₄)v=(|N₁-N|)h−h₁−h₃−h₄ (3)

wherein t₁, t₃ and t₄, or h₁, h₃ and h₄ all are hard to be accurately measured, thereby bringing a great difficulty to computation of the lift running speed v.

On this basis, the statistic times as 2 is taken for example, while another lift running distance is measured, a corresponding start floor number is N, a stop floor number is N₂ (which represents a 2^{nd} floor number here), a lift running distance H₂=(|N₂-N|)h, and the corresponding running time is T₂, wherein:

(T₂−t₁−t₃−t₄)v=(|N_{2 l -}N|)h−h₁−h₃−h₄ (4)

When the lift running distances are different but the environmental conditions are same, the starting accelerating time t₁, the braking decelerating time t₃ and the creeping time t₄, and correspondingly, the starting accelerating distance h₁, the braking decelerating distance h₃ and the creeping distance h₄ of the lift are changeless, so it is obtained by reducing the formula (3) from the formula (4):

(T₂-T₁)v=(|N₂-N₁|)h (5)

The lift running speed v can be easily computed and obtained according to the formula (5).

It is noteworthy that, when the preset statistic times is 2, the floor height data has to be obtained if the formula (5) needs to be utilized to compute to obtain the lift running speed v; and when the preset statistic times is greater than 2 and the floor height data can be obtained, the formula (Tₚ-T₁)v=(|Nₚ-N₁|)h (which has the same principle with the formula (5) and includes the formula (5)) can be utilized, and the value of p is any one value in a range from 2 to Q, thereby computing to obtain (Q−1) lift running speeds, wherein a running speed with a relatively larger error in the (Q−1) lift running speeds is removed, and an average lift running speed is computed and obtained by utilizing the residual lift running speeds.

It should be noted that, if the floor height data cannot be directly obtained, the lift running speed cannot be computed and obtained by utilizing the formula (5), and it may be solved by a simultaneous formula, and the statistic times should be greater than 2.

Specifically, the statistic times as 3 is taken for example, on the basis of the formula (5), another lift running distance is measured, a start floor number is N, a stop floor number is N₃ (which represents a 3^{rd} floor number here), a lift running distance H₃=(|N₃-N|)h, and the corresponding running time is T₃, wherein:

(T₃−t₁−t₃−t₄)v=(|N₃-N″)h−h₁−h₃−h₄ (6)

It may be obtained by reducing the formula (3) from the formula (6):

(T₃−T₁)v=(|N₃-N₁|)h (7)

A linear equation in two unknowns is formed by utilizing the formula (5) and the formula (7), so the floor height data h and the lift running speed v can be indirectly computed and obtained.

It should be noted that, when the preset statistic times is greater than or equal to 3 and the floor height data cannot be obtained, a formula (Tₚ-T₁)v=(|Nₚ-N₁|)h can be utilized, wherein the value of p is any one value in a range from 2 to Q, so (Q-1) computing formulas are obtained; and by simultaneously utilizing any two of the obtained computing formulas, the lift running speeds can be computed and obtained, wherein the running speeds with the relatively larger error are removed, and by utilizing the residual lift running speeds, an average lift running speed is computed and obtained.

Additionally, in order to avoid a disturbance that a user takes the lift in the lift running process, the lift running speed is measured by selecting a spare time of the lift. Furthermore, the difference between the destination floor number of each value from 2^{nd} to Q^{th} and the 1^{st} destination floor number is greater than one floor number, and the reason is: the total distance in the lift starting, braking and creeping processes is within 1 to 2 floor numbers, and if the difference is less than or equal to one floor number, the lift may not start to run at an average speed and then starts braking, thereby causing relatively larger running errors. When the lift starts and the time starts, if the measurement is on the spot, the start time of each value from 1^{st} to Q^{th} represents an up displayed arrow lighting time of the lift, and the stop time of each value from 1^{st} to Q^{th} represents an up displayed arrow extinguishing time of the lift; and if the measurement is not on the spot, a monitoring system can be utilized, the start time of each value from 1^{st} to Q^{th} is a sending time of a lift start signal extracted from a lift communication port, and the stop time of each value from 1^{st} to Q^{th} is a sending time of a lift stop signal extracted from the lift communication port. If there are similar fire floors (that is, the heights of the floors are difference), during measurement, the fire floors should be avoided and the floors with the same height should be selected in order to ensure that the measurement result is more accurate.

Furthermore, the present disclosure has the following beneficial effects:

(1) the measurement is simple, wherein the lift running speed can be computed and obtained by measuring the lift running time without those parameters including gear ratio, motor diameter, rotating speed and the like in methods given out by GB/T 10059-1997 Lifts-Testing Methods;

(2) the measurement is quick, wherein the lift running speed can be quickly computed and obtained by utilizing an average-speed running formula without the complex lift starting, braking and creeping process of the lift running process; and

(3) long-term monitoring of the lift is facilitated, wherein lift running may be monitored for a long term by utilizing the method provided by the present disclosure, especially the lift running speed can be monitored for a long term by utilizing a monitoring system; any aging or faults of the lift may be shown in the lift running speed variation, and if the lift running speed variation is over the international specified range, an alarm can be given to the lift maintenance department to overhaul the lift in order to ensure the safe running of the lift.

The use safety of the lift is closely linked to the life and property safety of the residents. It is a powerful manner to improve the safe running level of the lift and regulate the market and also is of a significant social meaning to improve the quality and service level of the lift and reduce the accident potentials that the lift running data is greatly monitored.

In the embodiments of the present disclosure, the q^{th} time difference is computed by utilizing the q^{th} stop time and the q^{th} start time; and if the q is greater than the statistic times Q, the difference between the time difference of each value from 2^{nd} to Q^{th} and the 1^{st} time difference, and the difference between the floor number of each value from 2^{nd} to Q^{th} and the 1^{st} floor number are respectively computed, the plurality of the lift running speeds are obtained by computing, and the average lift running speed is acquired; therefore, errors are reduced. Besides, a time difference of each value from 1^{st} to Q^{th} is a once-running total time of the lift, which comprises a starting accelerating time, a braking decelerating time, a creeping time and the like of the lift, and the starting accelerating time, the braking decelerating time, the creeping time and the like of the lift can be eliminated by respectively computing the difference between the time difference of each value from 2^{nd} to Q^{th} and the 1^{st} time difference, so the lift running speeds obtained by computing is not influenced by the starting accelerating time, the braking decelerating time, the creeping time and the like of the lift, and the computing method and the computation amount are largely simplified.

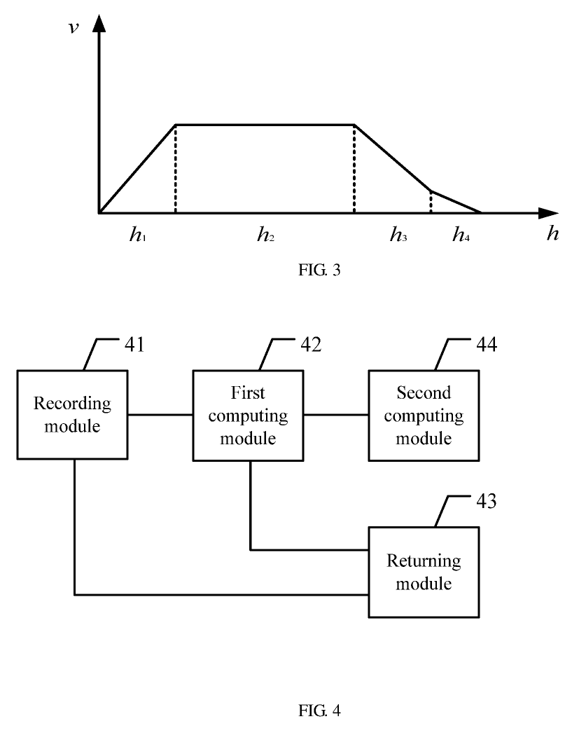

Referring to FIG.4, FIG. 4 is a structural schematic diagram of a lift running speed measurement system provided in a second embodiment of the present disclosure. Specifically, the system comprises:

a recording module 41, used for recording a q^{th} start time of a lift when the lift starts on a start floor, and recording a q^{th} stop time and a q^{th} floor number when the lift stops running on a q^{th} destination floor, wherein an initial value of the q is 1, and the q^{th} floor number is not equal to any one value in a range from the 1^{st} floor number to the (q−1)^{th} floor number;

a first computing module 42, used for computing a q^{th} time difference between the q^{th} stop time and the q^{th} start time;

a returning module 43, used for, if the q is less than Q, recording q=q+1 and returning the recording module 41, wherein the Q represents a preset statistic times, the Q is a positive integer and is greater than or equal to 2 if floor height data can be acquired, and the Q is a positive integer and is greater than or equal to 3 if the floor height data cannot be acquired; and

a second computing module 44, used for, if the q is greater than or equal to the Q, respectively computing a difference between a time difference of each value from 2^{nd} to Q^{th} and a 1^{st} time difference, and a difference between a floor number of each value from 2^{nd} to Q^{th} and a 1^{st} floor number, computing to obtain a plurality of lift running speeds, and deriving an average lift running speed.

Furthermore, the second computing module 44 is used for:

according to the following formula, respectively computing a difference between a time difference of each value from 2^{nd} to Q^{th} and a 1^{st} time difference, and a difference between a floor number of each value from 2^{nd} to Q^{th} and a 1^{st} floor number, computing to obtain a plurality of lift running speeds, and deriving an average lift running speed:

(Tₚ-T₁)v=(|Nₚ-N₁|)h

wherein Tₚ represents a p^{th} time difference, T₁ represents a 1^{st} time difference, v represents a lift running speed, Nₚ represents a p^{th} floor number, N₁ represents a 1^{st} floor number, and h represents the floor height data, wherein the value of the p is any one value in a range from 2 to Q.

Furthermore, the start time of each value from 1^{st} to Q^{th} represents an up displayed arrow lighting time of the lift, or a sending time of a lift start signal extracted from a lift communication port.

Furthermore, the stop time of each value from 1^{st} to Q^{th} represents an up displayed arrow extinguishing time of the lift, or a sending time of a lift stop signal extracted from the lift communication port.

Furthermore, a difference between a destination floor number of each value from 2^{nd} to Q^{th} and a 1^{st} destination floor number is greater than one floor number.

It should be noted that, description about a second embodiment of the present disclosure may refer to the related description of the first embodiment of the present disclosure, which is not described again.

In the embodiments of the present disclosure, the q^{th} time difference is computed by utilizing the q^{th} stop time and the q^{th} start time; and if the q is greater than the statistic times Q, the difference between the time difference of each value from 2^{nd} to Q^{th} and the 1^{st} time difference, and the difference between the floor number of each value from 2^{nd} to Q^{th} and the 1^{st} floor number are respectively computed, the plurality of the lift running speeds are obtained by computing, and the average lift running speed is acquired; therefore, errors are reduced. Besides, a time difference of each value from 1^{st} to Q^{th} is a once-running total time of the lift, which comprises a starting accelerating time, a braking decelerating time, a creeping time and the like of the lift, and the starting accelerating time, the braking decelerating time, the creeping time and the like of the lift can be eliminated by respectively computing the difference between the time difference of each value from 2^{nd} to Q^{th} and the 1^{st} time difference, so the lift running speeds obtained by computing is not influenced by the starting accelerating time, the braking decelerating time, the creeping time and the like of the lift, and the computing method and the computation amount are largely simplified.

It should be noted that, the present disclosure is not limited by the sequence of actions described, and certain steps may be carried out in another order or at the same time according to the present disclosure. Secondly, the embodiments described in the specification are preferred embodiments, in the above embodiments, the description of the embodiments each has a focus, and portions not described in detail in one embodiment may refer to the description of other embodiments.

The lift running speed measurement method and system provided by the present disclosure are described above. For those skilled in the art, the detailed description of embodiments and the application range can be changed according to the concept of embodiments of the present disclosure. To sum up, the specification content should not be interpreted as the limit to the present disclosure.

What is claimed is:

1. A lift running speed measurement method, wherein the method comprises:
step 1, recording a q^{th} start time of a lift when the lift starts on a start floor, and recording a q^{th} stop time and a q^{th} floor number when the lift stops running on a q^{th} destination floor, wherein an initial value of the q is 1, and the q^{th} floor number is not equal to any one value in a range from a 1^{st} floor number to a (q−1)^{th} floor number;
step 2, computing a q^{th} time difference between the q^{th} stop time and the q^{th} start time;
step 3, if the q is less than Q, recording q=q+1 and returning to carry out step 1, wherein the Q represents a preset statistic times, the Q is a positive integer and is greater than or equal to 2 if floor height data can be acquired, and the Q is a positive integer and is greater than or equal to 3 if the floor height data cannot be acquired; and
step 4, if the q is greater than or equal to the Q, respectively computing a difference value between a time difference of each value from 2^{nd} to Q^{th} and a 1^{st} time difference, and a difference value between a floor number of each value from 2^{nd} to Q^{th} and a 1^{st} floor number, computing to obtain a plurality of lift running speeds, and deriving an average lift running speed.

2. The method of claim 1, wherein the step 4 comprises the following step:
according to the following formula, respectively computing a difference value between a time difference of each value from 2^{nd} to Q^{th} and a 1^{st} time difference, and a difference value between a floor number of each value from 2^{nd} to Q^{th} and a 1^{st} floor number, computing to obtain a plurality of lift running speeds, and deriving an average lift running speed:
(Tₚ-T₁)v=(≡Nₚ-N₁|)h
wherein Tₚ represents a p^{th} time difference, T₁ represents a 1^{st} time difference, v represents a lift running speed, Nₚ represents a p^{th} floor number, N₁ represents a 1^{st} floor number, and h represents the floor height data, wherein the value of the p is any one value in a range from 2 to Q.

3. The method of claim 1, wherein the start time of each value from 1^{st} to Q^{th} represents an up displayed arrow lighting time of the lift, or a sending time of a lift start signal extracted from a lift communication port.

4. The method of claim 1, wherein the stop time of each value from 1^{st} to Q^{th} represents an up displayed arrow extinguishing time of the lift, or a sending time of a lift stop signal extracted from the lift communication port.

5. The method of claim 1, wherein a difference value between a destination floor number of each value from 2^{nd} to Q^{th} and a 1^{st} destination floor number is greater than one floor number.

6. A lift running speed measurement system, wherein the system comprises:
a recording module used for recording a q^{th} start time of a lift when the lift starts on a start floor, and recording a q^{th} stop time and a q^{th} floor number when the lift stops running on a q^{th} destination floor, wherein an initial value of the q is 1, and the q^{th} floor number is not equal to any one value in a range from a 1^{st} floor number to a (q−1)^{th} floor number;
a first computing module used for computing a q^{th} time difference between the q^{th} stop time and the q^{th} start time;
a returning module used for, if the q is less than Q, recording q=q+1 and returning the recording module, wherein the Q represents a preset statistic times, the Q is a positive integer and is greater than or equal to 2 if floor height data can be acquired, and the Q is a positive integer and is greater than or equal to 3 if the floor height data cannot be acquired; and
a second computing module used for, if the q is greater than or equal to the Q, respectively computing a difference value between a time difference of each value from 2^{nd} to Q^{th} and a 1^{st} time difference, and a difference value between a floor number of each value from 2^{nd} to Q^{th} and a 1^{st} floor number, computing to obtain a plurality of lift running speeds, and deriving an average lift running speed.

7. The system of claim 6, wherein the second computing module is further used for:
according to the following formula, respectively computing a difference value between a time difference of each value from 2^{nd} to Q^{th} and a 1^{st} time difference, and a difference value between a floor number of each value from 2^{nd} to Q^{th} and a 1^{st} floor number, computing to obtain a plurality of lift running speeds, and deriving an average lift running speed:
(Tₚ-T₁)v=(|Nₚ-N₁|)h
wherein Tₚ represents a p^{th} time difference, T₁ represents a 1^{st} time difference, v represents a lift running speed, Nₚ represents a p^{th} floor number, N₁ represents a 1^{st} floor number, and h represents the floor height data, wherein the value of the p is any one value in a range from 2 to Q.

8. The system of claim 6, wherein the start time of each value from 1^{st} Q^{th} represents an up displayed arrow lighting time of the lift, or a sending time of a lift start signal extracted from a lift communication port.

9. The system of claim 6, wherein the stop time of each value from 1^{st} Q^{th} represents an up displayed arrow extinguishing time of the lift, or a sending time of a lift stop signal extracted from the lift communication port.

10. The system of claim 6, wherein a difference between a destination floor number of each value from 2^{nd} to Q^{th} and a 1^{st} destination floor number is greater than one floor number.
